(19) United States
(12) Patent Application Publication
(10) Pub. No.: US 2024/0391805 A1
(43) Pub. Date: Nov. 28, 2024

(54) ELECTROCHEMICALLY ASSISTED ION EXCHANGE WATER TREATMENT DEVICE HAVING PARALLELY ARRANGED ELECTROCHEMICAL CELL AND REVERSE OSMOSIS UNIT

(71) Applicant: Zhejiang Qinyuan Water Treatment S. T. Co., Ltd., Ningbo City (CN)

(72) Inventors: Yao Wang, Shanghai (CN); Rul YAN, Shanghai (CN); Miaoquan HUANG, Ningbo (CN); Chengqian ZHANG, Ningbo (CN); Nan ZHAO, Ningbo (CN)

(73) Assignee: Zhejiang Qinyuan Water Treatment S. T. Co., Ltd., Ningbo City (CN)

(21) Appl. No.: 18/694,465

(22) PCT Filed: Sep. 21, 2022
(86) PCT No.: PCT/EP2022/076207

§ 371 Date: Mar. 22, 2024

(30) Foreign Application Priority Data
Sep. 24, 2021 (WO) PCT/CN2021/120493
Nov. 16, 2021 (EP) 21208359.6

(51) Int. Cl. C02F 1/469; C02F 1/44; C02F 1/461

(52) U.S. Cl. CPC C02F 1/4698; C02F 1/441; C02F 1/46109; C02F 2201/005; C02F 2201/4611

(57) ABSTRACT

The invention relates to an electrochemically assisted ion exchange water treatment device. Disclosed is a water treatment device comprising a first inlet feeding water into line L₀; a prefiltration unit; a water treatment unit comprising an electrochemical cell assembly comprising of at least one electrochemical cell; and a reverse osmosis unit, wherein the electrochemical cell assembly and the reverse osmosis unit are connected in parallel; a wastewater line for discarding wastewater from the electrochemical cell, through the waste water outlet; a wastewater line for discarding reject water from the reverse osmosis unit, through the reject water outlet; a carbon filtration unit positioned on line L₀ downstream of the point N; and an outlet for dispensing treated water. The invention provides a device which gives significantly higher recovery of treated water.

### FIELD OF THE INVENTION

The invention relates to an electrochemically assisted ion exchange water treatment device. More particularly, the invention relates to field of ion exchange, and to the use of ion exchange membranes in an electrochemical cell.

### BACKGROUND OF THE INVENTION

Ion exchange materials are used to remove or replace ions in solutions, for example in the production of high purity water by deionization, in waste water treatment (the extraction of copper ions from industrial waste streams), and in selective substitution of ions in solution (e.g., water softening processes in which “hard” divalent ions, such as calcium, are replaced by “soft” sodium or potassium ions). Ion exchange materials are typically divided into two categories, namely cation exchange and anion exchange, both types generally being solids or gels which comprise replaceable ions, or which chemically react with specific ions to function as ion exchange materials. They may be cross-linked or not cross-linked organic polymers or inorganic structures such as zeolites. Cation exchange materials comprise acidic groups such as —COOM, —SO₃M, —PO₃M₂, and —C₆H₄OM, where M is a cation (e.g., hydrogen, sodium, calcium, or copper ion) that exchange cations with no permanent change to the structure of the material. Cation exchange materials are commonly subdivided into “strong acid” and “weak acid” types, terms which refer to the ion exchange group's acid strength or pKa. Strong acid types such as those comprising —SO₃M groups function over virtually the full range of solution acid strengths (e.g., pH=0 to 15). Weak acid types such as those comprising —COOM only serve as ion exchange materials when the pH is near or above the acid group's pKa. Cation exchange materials also include those comprising neutral groups or ligands that bind cations through coordinate rather than electrostatic or ionic bonds. For example, a pyridine group affixed to a polymer will form a coordinate bond to Cu⁺² ion to remove it from solution. Other cation exchange materials include polymers comprising complexing or chelating groups (e.g., those derived from aminophosphoric acid, aminocarboxylic acid, and hydroxamic acid).

Anion exchange materials exchange anions with no permanent change to the structure of the material, and comprise basic groups such as —NR₃A, NR₂HA, —PR₃A, —SR₂A, or C₅H₅NHA (pyridinium), where R is typically an aliphatic or aromatic hydrocarbon group and A is an anion (e.g., hydroxide, bicarbonate or sulfonate). Anion exchange materials are commonly subdivided into “strong base” and “weak base” types. Weak base resins such as —NR₂HA and C₅H₅NHA exchange anions only when the solution pH is near or below the basic group's pKa, while strong base resins such as —NR₃A function over a much wider range of solution pH values. Ion exchange materials are useful in several forms, for example small or large spheres or beads, powders produced by pulverization of beads, and membranes. The simplest ion exchange membranes are monopolar membranes which comprise substantially only one of the two types of ion exchange materials: either cation or anion exchange materials. Another type of membrane is the water-splitting membrane, also known as bipolar, double, or laminar membranes. Water-splitting membranes are structures comprising a strong-acid cation exchange surface or layer (sulfonate groups; —SO₃M) and a strong-base anion exchange surface or layer (quaternary ammonium groups; —NR₃A) in combination such that in a sufficiently high electric field produced by application of voltage to two electrodes, water is irreversibly dissociated or “split” into its component ions H⁻ and OH⁻. The dissociation of water occurs most efficiently at the boundary between the cation and anion exchange layers in the water-splitting membrane, and the resultant H⁺ and OH⁻ ions migrate through the ion exchange layers in the direction of the electrode having an opposite polarity (e.g., H⁺ migrates toward the negative electrode).

Conventional ion exchange is a batch process typically employing ion exchange resin beads packed into columns. A single stream of solution to be treated (source solution) is passed through a column or channel. Ions in the solution are removed or replaced by the ion exchange material, and product solution or water emerges from the outlet of the column. When the ion exchange material is saturated with ions obtained from the source solution (e.g., its capacity is consumed or “exhausted”), the beads are regenerated with a suitable solution. Cation exchange resins are commonly regenerated using acidic solutions, and anion exchange resins are regenerated using basic solutions. During regeneration, the apparatus cannot be used for creating product solution or water. Regeneration is concluded with a rinsing step which removes entrapped regenerant solution. Such batch processes are contrasted with continuous processes that employ membranes which do not require a regeneration step.

Several important benefits accrue from batch ion exchange operation for solution treatment rather than a continuous process. First, ion exchange materials are highly selective, and exclusively remove or replace ions in solution, largely ignoring neutral groups. They may also be very selective in the removal or replacement of one type of ion over other ions. For example in water softening processes, cation exchange materials comprising sulfonate groups selectively extract multivalent ions such as calcium and magnesium from solution while leaving the monovalent ion concentration (e.g., sodium) unaffected. Water softening occurs because the sulfonate group has a ten-fold greater affinity (selectivity) for divalent ions than for monovalent ions. Alternatively, a chelating cation exchange group such as iminodiacetic acid is particularly suitable for selectively extracting copper ion from solutions containing other ions.

This ion exchange group has an eight order-of-magnitude greater affinity for copper ion than for sodium ion. A second advantage of batch ion exchange processes is their greater resistance to fouling from either biological growths (e.g., algae) or mineral scale. Strong acids and bases are most often used to regenerate cation and anion exchange materials, respectively, creating an environment in which biological organisms cannot survive. Mineral scale forms in neutral or basic environments (pH>7) in the presence of multi-valent cations; scale typically comprises calcium and magnesium carbonates, hydroxides and sulfates. Build-up of scale on surfaces or in channels of continuous apparatus for water treatment has a detrimental effect on ion removal efficiencies. Formation of scale in batch ion exchange systems is a less serious problem because of the frequent regeneration of cation exchange materials (where the multivalent cations are concentrated) with strong acids which rapidly dissolve scale. A third advantage is the potential to produce concentrated regenerant effluents (containing the ions removed in the preceding solution treatment step). This is important when the ion removed by the ion exchange material is the chemical of interest and one desires its isolation (for example an amino acid or protein removed from a cell culture). The ability to produce more concentrated regenerant effluents provides the further important benefits of consuming less water and placing a smaller burden on waste treatment plants.

Although batch type ion exchange processes have important benefits, the need for regenerant chemicals renders such processes expensive and environmentally unfriendly. The environmental costs associated with the purchase, storage, handling, and disposal of used toxic or corrosive regenerant chemicals such as sulfuric acid, hydrochloric acid, and caustic soda prohibit use of this ion exchange process in many applications. Even in water softening, while the sodium or potassium chloride regenerant is much less hazardous, the need for consumers to haul 22.67 kg (50 lb) bags of salt home from the grocery store to refill their softeners every several weeks is a major inconvenience. In addition, salt-rich regeneration effluent from water softeners which is washed into the sewer can be difficult to handle in municipal waste treatment facilities. Another negative environmental impact from chemical regeneration results from the need for large quantities of water to rinse the regenerated ion exchange column and prepare it for a subsequent operating step. Water is not only scarce in many regions of the world, but the resultant large volume of dilute waste rinse water must also be treated (e.g., neutralized) before disposal.

Continuous processes that avoid regenerant chemicals for the electrochemical regeneration of ion exchange materials are disclosed in for example U.S. Pat. No. 3,645,884 (Gilliland), U.S. Pat. No. 4,032,452 (Davis), and U.S. Pat. No. 4,465,573 (O'Hare). In these electrodialysis systems, the ion exchange material, most often in bead form, is separated from two electrodes by a multitude of monopolar cation and anion exchange membranes; the ion exchange bead material is then continuously regenerated by an electrodialysis process in which ions migrate in an electric field through the solution, beads, and compatible monopolar membranes (i.e., cations pass through monopolar cation exchange membranes, and anions pass through monopolar anion exchange membranes), until they are prevented from further movement by incompatible monopolar membrane barriers. This property of monopolar ion exchange membranes to pass ions of one polarity while preventing passage of ions of the opposite polarity is referred to as permselectivity. Because it is a continuous process, electrodialysis is characterized by two separate, contiguous solution streams of substantially different compositions, namely a product water stream from which ions are continuously removed, and a waste water stream into which these ions are concentrated. A primary advantage of the electrodialysis process versus conventional ion exchange is its continuous operation which reduces down-time or avoids the need for a second (redundant) apparatus to operate during the regeneration of a first ion exchange column. A second important advantage is that the electrodialysis waste stream only contains the ions removed from the product water due to using electrical energy rather than chemical energy for removing or replacing ions. Because chemical regeneration in conventional ion exchange is a relatively slow and inefficient process, and it is important to minimize down-time, excess chemicals are typically employed. Thus, the regeneration solution in batch ion exchange processes contains a considerable excess of chemicals in addition to the ions which were removed from the product water in the preceding cycle. This is a significant complicating factor if one desires to recover the previously removed ions from the regenerant (e.g., copper ion). The excess chemicals also create a still further burden on waste treatment systems.

Continuous electrodialysis water treatment processes suffer from several drawbacks. First, it is a much less selective ion removal process that is governed by mass transport rates rather than by chemical equilibria. Since electrodialysis apparatus require the use of highly conductive membranes for good electrical efficiency and high mass transport rates, there is little latitude for optimizing membranes for the property of selectivity. A second drawback is that electrodialysis apparatus are prone to mineral scale fouling that interferes with flow of liquid, migration of ions, or effectiveness of the electrodes, causing eventually plugging up of the equipment. Thus, in many water deionization electrodialysis apparatus water must be softened prior to passing it through the device. Alternatively, when multivalent ions are introduced into the apparatus, the electrode polarity may be occasionally reversed as described in U.S. Pat. No. 2,863,813 (Juda), which provides an acidic environment that dissolves mineral scale. However, such polarity reversal does not substantially change the ion exchange capacity of the membranes or ion exchange materials.

Devices called ion-binding electrodes (IBE's) combine the benefits of conventional batch ion exchange processes with electrochemical regeneration, as disclosed in U.S. Pat. No. 5,019,235 (Nyberg), U.S. Pat. No. 4,888,098 (Nyberg), and U.S. Pat. No. 5,007,989 (Nyberg). IBE's typically comprise conductive polymer electrodes, surrounded by and secured to monopolar ion exchange membranes. IBE's operate in batch-mode and provide good ion exchange selectivity, for example the extraction of multivalent ions from solutions containing large concentrations of monovalent ions (e.g., water softening or copper ion extraction processes). Mineral scale fouling of IBE membranes is reduced during the electrochemical regeneration step which involves the production of H⁺ by water electrolysis.

Third, concentrated regenerant effluents may be obtained using IBE devices, facilitating either the recovery of ions in the effluent or its disposal as waste. Furthermore, device design and manufacturing complexity is significantly lower for IBE devices as compared to electrodialysis systems because they operate with a single solution stream, and the ion exchange membranes are supported on electrodes. In contrast, the thin, flexible monopolar membranes used in electrodialysis must be carefully positioned using spacers to obtain efficient ion removal and maintain separation of the two solution streams. IBE cells, however, have two significant drawbacks. They require that the cation and anion exchange membranes are secured to opposite sides of an electrode, thereby increasing cell cost and size, and the electrolysis of water forms hydrogen and oxygen gases which may either damage the interface between the electrode and membranes or interfere with solution flow through the cell.

Electrochemical cells comprising water-splitting ion exchange membranes for production of acids and bases from a variety of salt solutions are disclosed in for example U.S. Pat. No. 2,829,095 (Oda), U.S. Pat. No. 4,024,043 (Dege), and U.S. Pat. No. 4,107,015 (Chlanda). These are continuously operated cells which again necessarily comprise two solution streams, in this case two product streams: one an acid solution and the other a base solution. To operate, these cells must comprise monopolar ion exchange membranes to separate the two solution streams. For example, the water-splitting membrane apparatus described in U.S. Pat. No. 2,829,095 (Oda), suitable for the continuous production of HCl and NaOH from the influent NaCl, for example, is comprised of an anion exchange membrane and a cation exchange membrane positioned between each pair of water-splitting membranes of the cell. In the absence of the monopolar membranes, product effluents HCl and NaOH would mix to form water and NaCl, preventing the cell from functioning.

An alternative design and application of an electrochemical cell comprising water-splitting membranes for the continuous removal of ions from a solution stream is described in U.S. Pat. No. 3,654,125 (Leitz). This is a variant of the continuous electrodialysis cell that employs water-splitting membranes rather than monopolar ion exchange membranes to create two separate solution streams: one the product stream from which ions are removed, and the other the waste stream into which ions are concentrated. The anion exchange layers or surfaces of the water-splitting membranes are oriented in the cell to face each other, as are the cation exchange layer surfaces. Only with this orientation can the peculiar NaCl permselectivity characteristics of water-splitting membranes be exploited for the continuous electrodialysis separation process. The Leitz cell and process has the same drawbacks described for the electrodialysis process including poor ion selectivity, susceptibility to fouling by mineral scale or biological growths, and production of considerable water waste volumes. Furthermore, the Leitz cell and process is largely limited to the treatment of NaCl solutions.

Due to their continuous operation, the water-splitting membrane cells of the prior art, both the acid/base production cells and the ion removal cell of Leitz, share the characteristic that the water-splitting membranes comprise a combination of strong-acid sulfonate and strong-base quaternary ammonium ion exchange layers rather than employing other ion exchange materials. This particular combination provides membranes having particularly low electrical resistance and high permselectivity.

US patent U.S. Pat. No. 5,788,826 (Eric Nyberg, 1998) provides ion exchange apparatus and method which provide the benefits of batch ion exchange processes including high ion selectivity, resistance to mineral scale fouling, and concentrated regenerant effluent solutions and an apparatus and method for the regeneration of ion exchange materials which use electrical power rather than introducing chemicals for regeneration. This eliminates the inconvenience and environmental hazards associated with regenerant chemicals and reduces rinse water volumes and avoids the contamination of regenerant effluent solutions with chemicals. However, the invention has some drawbacks such as when the invention is used for water treatment it could only remove ionic pollutants not neutral pollutants, such as particles, pesticide, VOCs. Therefore, there is a need of a device and a process to address these drawbacks.

CN113402082 A (Foshan, 2021) discloses a water purification device that contains a single-flow-channel desalination assembly and a double-flow-channel desalination assembly which are arranged in parallel, a series of pathways and valves. The double-flow-channel desalination assembly purifies water flowing in through the first water inlet, generated pure water flows into the single-flow-channel desalination assembly through the first water outlet and the second port, and salt substances in the single-flow-channel desalination assembly are flushed by the flowing-in pure water and then flow into the third pipeline through the first port. The pure water generated by purification treatment of the double-flow-channel desalination assembly is used for flushing and regenerating the single-flow-channel desalination assembly, so that the scaling risk during regeneration of the single-flow-channel desalination assembly is reduced.

CN113493272 A (Foshan, 2021) discloses a household water purification device which comprises a single-flow-channel desalination assembly. When the single-flow-channel desalination assembly purifies flowing water, waste water is not discharged, and the utilization rate of the water is high; the flow direction of water in the single-flow-channel desalination assembly during flushing regeneration is opposite to that of water in the single-flow-channel desalination assembly during water purification, and the flushing efficiency is high.

### SUMMARY OF THE INVENTION

First aspect of the present invention provides a water treatment device comprising:
a) a first inlet (2A) feeding water into line L₀;
b) a prefiltration unit (10);
c) a water treatment unit comprising an electrochemical cell assembly (20) comprising of at least one electrochemical cell; and a reverse osmosis unit (RO), wherein the electrochemical cell assembly (20) and the reverse osmosis unit (RO) are connected in parallel; and wherein the electrochemical cell (EC) comprises:
   (i) a housing (25) having first (40) and second (45) electrodes;
   (ii) at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and
   (iii) a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution;
      wherein the line L₀ branches into lines L₁ and L₂ at point M, line L₁ leading to the electrochemical cell (EC) and L₂ leading to the reverse osmosis unit (RO);
      wherein L₁ further branches into line FL at point O, upstream of the electrochemical cell (EC), to form a bypass loop to the electrochemical cell (EC) and merges back into the line L₁ at point P, downstream of the electrochemical cell (EC); and
      wherein lines L₁ and L₂ merge back into line L₀ at point N downstream of the electrochemical cell (EC) and the reverse osmosis unit (RO);
d) a wastewater line (WL1) for discarding wastewater from the electrochemical cell (EC), through the waste water outlet (5B);
e) a wastewater line (WL2) for discarding reject water from the reverse osmosis unit (RO), through the reject water outlet (5C);
f) a carbon filtration unit (17) positioned on line L₀ downstream of the point N; and
g) an outlet (5A) for dispensing treated water
   wherein on the line L₀ a valve V1 is positioned
   downstream of prefiltration unit (10) and upstream of point M; a valve FLV is positioned on the line FL upstream of point O and upstream of the electrochemical cell (EC), a valve V1A is positioned on line L₁, downstream of point O and upstream of the electrochemical cell (EC).

Second aspect of the present invention provides a method of treating water using the device of the first aspect, the method comprising steps of:
(i) allowing the water to filter through the prefiltration unit (10)
(ii) treating water in the water treatment unit comprising an electrochemical cell assembly (20) comprising of at least one electrochemical cell (EC); and a reverse osmosis unit (RO), wherein the electrochemical cell assembly (20) and the reverse osmosis unit (RO) are connected in parallel, each cell (20) comprising:
   a) first and second electrodes (40, 45);
   b) at least one water-splitting membrane between the electrodes, each at least one water-splitting membrane (100) between the electrodes (40, 45), each water-splitting membrane (100) comprising ion exchange layers A and B, one a cation exchange layer facing the first electrode (40) and the other an anion exchange layer facing the second electrode (45), which layers contain ions I_{1A} and I_{1B} respectively;
      wherein a unitary and contiguous solution channel is defined by the cation and anion exchange layer surfaces (105, 110) of the membranes, the solution channel (122) abutting both electrodes (40, 45) and extending continuously from the inlet (30) to the outlet (35) of the housing (25);
   c) an ion-containing solution electrically connecting the electrodes (40, 45) and the water-splitting membranes (100);
      in which cell ions I_{1A} and I_{1B} are replaced by ions I_{2A} and I_{2B}, respectively;
      wherein the water-splitting membranes (100) are arranged to provide a continuous channel (122) that allows a stream of solution to flow past both the cation and anion exchange layer surfaces (105, 110) of the water-splitting membranes (100);
      wherein the solution in at least one channel (122) of the cell (20) is simultaneously exposed to a cation and an anion exchange layer surface (105, 110) of water-splitting membranes (100); and
(iii) allowing the water from the electrochemical cell assembly (20) to be filtered by the carbon filtration unit (17);
   wherein at a given point in time the device operates in anyone of the two stages, deionization stage and regeneration stage and the water obtained by the method steps (i) to (iii) are during the deionization state,
      wherein when the device is in regeneration stage, the electrochemical cell (EC) allows water to flow from L₁ through point O into the feed water line FL into the into the electrochemical cell (EC) though point P in opposite direction with respect to flow of water during the deionization stage; and water exiting from the electrochemical cell (EC) which is in the stage of regeneration is discarded through waste water line WL1,
      wherein during the regeneration stage valves V1, FLV and WLV1 are open and valves and V2, V1A, and a valve WLV2 positioned on the line WL2 are closed and during the deionization stage, valves FLV and WLV1 are closed and valves V1, V1A, WLV2 and V2 are open

### BRIEF DESCRIPTION OF DRAWINGS

FIG. 1 is a schematic representation of water flow in the water treatment device of first aspect;

FIG. 2 is a schematic sectional side view of an embodiment of the electrochemical cell of the present invention;

FIG. 3 is a schematic sectional diagram of a water-splitting ion exchange membrane showing the anion and cation exchange surfaces;

FIG. 4 is a schematic sectional diagram of another embodiment of a water-splitting ion exchange membrane comprising multiple cation and anion exchange layers.

### DETAILED DESCRIPTION OF THE INVENTION

The present invention provides a water treatment device comprising an electrochemical cell assembly and methods for removing ions present in solutions, and replacing ions in ion exchange materials.

The present invention provides a water treatment device as claimed in claim 1.

The present inventors surprisingly found that the water treatment device of the present invention provided continuous operation of the water treatment device. However, for a system using a single electrochemical cell, it was necessary to stop the cell and the water output for repolarization of the cell for providing stable salt removal performance.

Further, it was a surprising finding of the inventors of the present invention that compared with using two 400G RO in parallel, using one electrochemical cell cartridge to replace one of the RO filter can increase the system water recovery rate. The findings of the present invention also resulted in increase of water output flux while maintaining the salt removal rate. At the same time, the system could work continuously compared with system using only electrochemical cartridges.

The terms “including”, “comprising”, “containing” or “having” and variations thereof as used herein are meant to encompass the items listed thereafter as well as additional items. Unless specified or limited otherwise, the terms “mounted,” “connected,” “supported,” and “coupled” and variations thereof are used broadly and encompass direct and indirect mountings, connections, supports, and couplings.

Throughout the description of the invention the terms “regeneration” and “reverse polarization” are used interchangeably and intended to mean the same.

The term “electrochemical cell” or “electrochemical cell cartridge” or the term “electrochemical cell assembly” means to include an assembly of at least one electrochemical cell.

The present invention provides a water treatment device comprising an electrochemical ion exchange system comprising:
(a) the electrochemical cells of first aspect;
(b) a voltage supply for supplying a voltage to the first and second electrodes; and
(c) means for flowing an influent solution stream through the cell.

It is preferred that in the electrochemical ion exchange system of the present invention, the water-splitting membranes are positioned so that an electric field generated by the electrodes upon application of a voltage by the voltage supply is directed substantially transverse to the anion and cation exchange surfaces of the water-splitting membranes.

The present invention provides a water treatment device having a first inlet leading to a first feeding line which is in fluid communication with a prefilter which allows the raw or unfiltered water to filter through a prefiltration unit which functions to remove suspended solids, for example particles, rust, colloid and etc. the water line exiting from the prefiltration unit L₀ is preferably divided into lines L₁ and L₂ at point M, preferably a valve V1 is positioned downstream of the prefiltration unit and upstream of point M; L₂ is preferably the route to the reverse osmosis unit; L₁ is the line leading to electrochemical cell via valve V1A and preferably branches into file FL at point O, it is preferred that valve V1A is downstream of point O and more preferable that the point O and valve V1A are positioned upstream of the electrochemical cell.

It is preferred that the line L₁ further branches out at point Q to waste water line WL1, it is further preferred that point Q is positioned between valve V1A and electrochemical cell, more preferably downstream of valve V1A and upstream of the electrochemical cell. It is preferred that a valve WLV1 is positioned on the waste water line WL1. It is preferred that waste water from the electrochemical cell flows out through the waste water outlet via waste water line WL1. The line FL preferably has a valve FLV positioned on it. It is further preferred that the line FL bypasses the electrochemical cell and merges into line L₁ downstream of the electrochemical cell at point P.

It is preferred that line L₁ and line L₂ merge back into line L₀ downstream of the reverse osmosis unit and the electrochemical cell at point N. It is preferred that a valve V2 is positioned on line L₀ and more preferably V2 is positioned downstream of the carbon filtration unit on Line L₀ and further preferably the treated water is collected from treated water outlet positioned downstream of the valve V2.

The line L₂ leads to the reverse osmosis unit and it is preferred that the reject water of the reverse osmosis unit flows into waste water line WL2 and more preferably a valve WLV2 is positioned on the line WL2. The reject of reverse osmosis unit flows out through RO reject outlet.

It is preferred that the water treatment system operates in two states, deionization state and reverse polarization state.

The FL bypasses the electrochemical cell and it is preferred that the FL is operably functional through a valve FLV so that the line is operational only when it is in reverse polarization/regeneration state.

When electrochemical cell is in deionization state, the water enters the inlet into line L₀, subsequently entering the prefilter, and entering lines L₁ and L₂ at point M. Water in line L₁ preferably passes through open valve V1A and enters into the electrochemical cell finally exits the electrochemical cell to enter line L₁ and then merges with line L₂ into line L₀ at point N. It is preferred that the water from point M which enters into the reverse osmosis unit is treated at the unit and the reject water is discarded through the RO reject outlet, preferably through the valve WLV2. The treated RO permeate water then merges with line L₁ at point N. Subsequently the water downstream of point N in line L₀ is filtered through the carbon filtration unit and collected through the treated water outlet.

It is preferred that during the deionization stage, the lines FL and WL1 are closed and through operably functional valves FLV and WLV1 respectively.

Whereas when the electrochemical cell is in reverse polarization/regeneration state, the line L₀ is open and the water is allowed to enter lines L₁ and L₂ through point M, the reject water line WL2 of RO unit is closed and the output water line is closed through operably functional valve V2, preferably line L₁ beyond point O is closed to restrict the entry of water into electrochemical cell from line L₁. Instead, the reject water from RO flows back into the RO unit and into L₂ into line L₁ and subsequently into line FL preferably through operably functional valve FLV, through point P into the electrochemical cell in a direction opposite to the flow of water during deionization state. The water passing through the electrochemical cell from point P subsequently passes through the cell and the waste water enters into line WL1 and discarded into waste water outlet preferably through operably functional valve WLV1.

The water treatment device comprises an electrochemical cell capable of removing ions from a solution stream, the cell comprising:
a) a housing having first and second electrodes;
b) at least one water-splitting ion exchange membrane positioned between the electrodes, the water-splitting membrane comprising (i) a cation exchange surface facing the first electrode, and (ii) an anion exchange surface facing the second electrode; and
c) a unitary and contiguous solution channel that allows an influent solution stream to flow past (i) the electrodes, and (ii) both the cation and anion exchange surfaces of the water-splitting membrane.

The water treatment device comprises at least one electrochemical cell capable of removing ions from a solution stream, and one reverse osmosis unit (RO), the electrochemical cell and the RO connected in parallel with each other, the cell comprising:
(a) a housing having first and second electrodes;
(b) at least one water-splitting ion exchange membrane positioned between the electrodes, the water-splitting membrane comprising (i) a cation exchange surface facing the first electrode, and (ii) an anion exchange surface facing the second electrode; and
(c) a solution stream pathway defined by the water-splitting membrane, the solution stream pathway having (i) an inlet for influent solution stream, (ii) at least one channel that allows influent solution stream to flow past at least one surface of the water-splitting membrane to form one or more treated solution streams, and (iii) a single outlet that combines the treated solution streams to form a single effluent solution.

The water treatment device comprises an electrochemical cell assembly capable of removing ions from a solution stream, the assembly comprising of electrochemical cell (EC) and RO unit connected in parallel with each other, each cell comprising:
(a) a housing having first and second electrodes;
(b) at least one water-splitting ion exchange membrane positioned between the electrodes, the water-splitting membrane comprising (i) a cation exchange surface facing the first electrode, and (ii) an anion exchange surface facing the second electrode; and
(c) a unitary and contiguous solution channel that allows an influent solution stream to flow past (i) the electrodes, and (ii) both the cation and anion exchange surfaces of the water-splitting membrane.

The present invention also provides a water treatment device in accordance with claim 1.

It is preferred that in the electrochemical cell the solution stream pathway comprises a unitary and contiguous solution channel that flows past both the cation and anion exchange surfaces of the water-splitting membrane.

It is preferred that in the electrochemical cell the solution stream pathway comprises a unitary and contiguous solution channel that is connected throughout in an unbroken sequence and extends substantially continuously from the inlet to the outlet.

It is preferred that the electrochemical cell comprises substantially no monopolar ion exchange membranes.

It is preferred that the electrochemical cell comprises a plurality of water-splitting membranes, and wherein the solution stream pathway comprises a unitary and contiguous solution channel that flows past (i) the electrodes, and (ii) both the cation and anion exchange surfaces of each water-splitting membrane.

It is preferred that the electrochemical cell comprises a plurality of water-splitting membranes, and wherein the solution stream pathway comprises a plurality of channels, each channel allowing the influent solution to flow past cation and anion exchange surfaces of adjacent water-splitting membranes.

It is preferred that the electrochemical cell comprises substantially no monopolar ion exchange membranes between the adjacent water-splitting membranes.

It is preferred that the electrochemical cell comprises a plurality of interdigited water-splitting membranes having alternating ends attached to the housing.

It is preferred that in the electrochemical cell the water-splitting membranes are rolled in a spiral arrangement to form a cylindrical shape, and (ii) the first or second electrode comprises a cylinder enclosing the spiral arrangement of water-splitting membranes.

It is preferred that in the electrochemical cell the solution stream pathway allows the influent solution stream to flow past both the cation and anion exchange layer surfaces of the water-splitting membranes in the direction of the spiral.

It is preferred that in the electrochemical cell the water-splitting membrane comprises at least one of the following characteristics:
(a) a cation exchange surface comprising a chemical group selected from the group consisting of —SO₃M, —COOM, —PO₃M₂, —C₆H₄OM, aliphatic amines, aromatic amines, aliphatic phosphines, aromatic phosphines, aliphatic sulfides, aromatic sulfides, aminophosphoric acid, aminocarboxylic acid, hydroxamic acid, and mixtures thereof, where M is a cation;
(b) an anion exchange surface comprising a chemical group selected from the group consisting of aliphatic amines, aromatic amines, aliphatic phosphines, aromatic phosphines, aliphatic sulfides, aromatic sulfides, and mixtures thereof;
(c) at least one exchange surface of each water-splitting membrane comprises an average pore size of at least about 1 micron;
(d) at least one exchange surface of each water-splitting membrane comprises a pore volume of at least 10 volume %; or
(e) the membranes are heterogeneous and comprise cross-linked water-swellable polymeric host material.

It is preferred that in the electrochemical cell the cation exchange surfaces of the water-splitting membranes comprise at least two cation exchange layers each comprising different cationic chemical groups.

It is preferred that in the electrochemical cell an inner cation exchange layer comprises SO₃⁻ chemical groups, and an outer cation exchange layer comprises an ion exchange chemical group other than SO₃⁻.

It is preferred that in the electrochemical cell of the present invention the anion exchange surfaces of the water-splitting membranes comprise at least two anion exchange layers each comprising different cationic chemical groups.

It is preferred that in the electrochemical cell of the present invention an inner anion exchange layer comprises NR₃⁺ groups, and an outer anion exchange layer comprises ion exchange groups other than NR₃⁺ where R is selected from the group consisting of aliphatic hydrocarbons, aliphatic alcohols, and aromatic hydrocarbons.

### Method

Disclosed is a method of treating water using device of the present invention.

It is preferred that voltage is applied to the electrochemical cell in the method for a better ion exchange speed and increased salt removal rate.

The present invention also provides a method using the device of the present invention for replacing ions in an ion exchange material of an electrochemical cell comprising:
(a) first and second electrodes;
(b) at least one water-splitting membrane between the electrodes, each water-splitting membrane comprising ion exchange layers A and B, one a cation exchange layer facing the first electrode and the other an anion exchange layer facing the second electrode, which layers contain ions I_{1A} and I_{1B} respectively;
wherein a unitary and contiguous solution channel is defined by the cation and anion exchange layer surfaces of the membranes, the solution channel abutting both electrodes and extending continuously from the inlet to the outlet of the housing;
(c) an ion-containing solution electrically connecting the electrodes and the water-splitting membranes;
in which cell ions I_{1A} and I_{1B} are replaced by ions I_{2A} and I_{2B}, respectively;

The present invention also provides a method for removing multivalent ions from a solution, which method comprises applying a voltage to an assembly comprising first and second electrochemical cells:
(a) the first electrochemical cell comprising:
   (i) first and second electrodes;
   (ii) at least one water-splitting membrane between the electrodes, each water-splitting membrane comprising a cation exchange layer A and an anion exchange layer B, which layers comprise ions I_{4A} and I_{4B}, respectively, ions I_{4A} and I_{4B} comprising substantially H⁺ and OH⁻, respectively, wherein the cation exchange layers face the first electrode and the anion exchange layers face the second electrode, in which cell there is a unitary and contiguous solution channel, and
   (iii) a solution containing ions I_{2A} and I_{2B} which electrically connects the electrodes and water-splitting membrane, in which cell ions I_{4A} and I_{4B} are replaced by ions I_{2A} and I_{2B};
(b) a second electrochemical cell, comprising:
   (i) first and second electrodes;
   (ii) at least one water-splitting membrane arranged between the electrodes, each water-splitting membrane comprising a cation exchange layer A and an anion exchange layer B, which layers comprise ions I_{5A} and I_{5B}, respectively, ions I_{5A} and I_{1B} comprising monovalent ions other than H⁺ and OH⁻, respectively, wherein the cation exchange layers face the first electrode and the anion exchange layers face the second electrode, in which cell there is a unitary and contiguous solution channel, and
   (iii) a solution containing ions I_{2A} and I_{2B} which electrically connects the electrodes and water-splitting membrane, in which cell ions I_{5A} and I_{5B} are replaced by ions I_{2A} and I_{2B}, respectively.

It is preferred that in the method of present invention the cell comprises substantially no monopolar ion exchange membranes.

It is preferred that in the method of present invention the water-splitting membranes are arranged to provide a continuous channel that allows a stream of solution to flow past both the cation and anion exchange layer surfaces of the water-splitting membranes.

It is preferred that in the method of present invention the solution in at least one channel of the cell is simultaneously exposed to a cation and an anion exchange layer surface of water-splitting membranes.

It is preferred that in the method of present invention wherein H⁺ and OH⁻ are produced within the water-splitting membranes and pass through ion exchange layers A and B, respectively, causing ions I_{1A} and I_{1B} to be replaced by ions I_{2A} and I_{2B} respectively.

It is preferred that in the method of present invention the polarities of ions I_{1A} and I_{1B} are the same as those of the H⁺ and OH⁻ ions causing their replacement.

It is preferred that in the method of present invention polarities of ions I_{1A} and I_{1B} are opposite those of the H⁺ and OH⁻ ions causing their replacement.

It is preferred that the method of present invention comprises the additional step of reversing the polarity of the electrodes causing ions I_{2A} and I_{2B} to be replaced by ions I_{3A} and I_{3B}, respectively.

It is preferred that in the method of present invention in the reversing step, the OH⁻ and H⁺ are produced within the water-splitting membranes and pass through ion exchange layers A and B, respectively, causing ions I_{2A} and I_{2B} to be replaced by ions I_{3A} and I_{3B}, respectively.

It is preferred that the method of present invention comprises the additional step of terminating the current, causing ions I_{2A} and I_{2B} to be replaced by ions I_{3A} and I_{3B}, respectively.

It is preferred that in the method for removing multivalent ions from a solution comprises the additional step of introducing another solution into the second electrochemical cell and reversing the polarity of the electrodes causing ions I_{2A} and I_{2B} to be replaced by ions I_{4A} and I_{4B}, respectively.

It is preferred that in the method for removing multivalent ions from a solution, in both cells the water-splitting membranes are arranged to provide a continuous solution stream in each cell which flows past both the cation and anion exchange layer surfaces of their water-splitting membranes.

It is preferred that in the method for removing multivalent ions from a solution the solution in at least one channel of the first and second cells is simultaneously exposed to a cation and an anion exchange layer surface of water-splitting membranes.

It is preferred that in the method for removing multivalent ions from a solution the step of flowing a solution stream through the first and second cells includes the step of controlling the flow rates of the solution through the first and second cells to obtain a predetermined concentration of ions in the effluent streams from the cells.

It is preferred that in the method for removing multivalent ions from a solution the step of controlling the flow rates of the solution through the first and second cells to obtain a predetermined concentration of ions in effluent streams from the cells includes the step of monitoring the composition of the effluent streams from the first and second cells, and adjusting the flow rates of the solution through the first and second cells in relation to the composition of the effluent streams.

It is preferred that the method for removing multivalent ions from a solution comprises a third electrochemical cell comprising:
(a) first and second electrodes;
(b) at least one water-splitting membrane arranged between the electrodes, each water-splitting membrane comprising a combination of a cation exchange layer A and an anion exchange layer B, which layers comprise ions I_{2A} and I_{2B}, wherein the cation exchange layers face the first electrode and the anion exchange layers face the second electrode, in which cell there is a unitary and contiguous solution stream, and
(c) a solution which electrically connects the electrodes and water-splitting membranes, wherein the polarity of the first and second electrodes in the third cell is reversed relative to that for the first and second cells, such that in the third cell ions I_{2A} and I_{2B} are replaced by ions I_{4A} and I_{4B}, respectively.

It is preferred that in the method for removing multivalent ions from a solution the replacement of ions I_{2A} and I_{2B} by ions I_{4A} and I_{4B}, respectively, in the third cell occurs while the first and second cells are removing multivalent ions from their separate solution stream.

It is preferred that the prefiltration unit includes polypropylene sediment filter, microfiltration filter, ultrafiltration filter and combinations thereof.

The ultrafiltration unit of the present invention preferably comprises of at least two chambers and preferably four chambers which allows the water to flush quicker when the flux is same and therefore results in longer lifetime compared with traditional ultrafiltration unit. It is preferred that the ultrafiltration unit is washed regularly to remove the particulates and colloid resulting in prolonged lifetime of the device.

The ultrafiltration unit is preferably positioned upstream of the electrochemical cell assembly and preferably downstream of the inlet of the water treatment device.

The ultrafiltration unit preferably functions to filter out the suspended solids, larger particles, colloidal matter and proteins from water through an ultrafiltration membrane. It is preferred that the ultrafiltration unit also removes bacteria, protozoa and some viruses from the water

The carbon filter is preferably used to remove pollutants which cannot be removed by ultrafiltration unit and electrochemical cell. It is preferred that the carbon filter is an activated carbon filter. The carbon filter could be selected from VOC removal carbon, heavy metal removal carbon, sterilizing/antibacterial carbon, broad-spectrum carbon, Vitamin C filter, herbal filter, strontium-carbon filter, or any other mineral-containing carbon filter.

It is preferred that the carbon filter is positioned downstream of the electrochemical cell assembly and more preferably the water is dispensed after exiting from the carbon filter for use.

In the method of the present invention that during the regeneration state valves V1, FLV and WLV1 are open and valves and V2, V1A, and a valve WLV2 positioned on the line WL2 are closed.

In the method of the present invention that during the deionization stage, valves FLV and WLV1 are closed and valves V1, V1A, WLV2 and V2 are open.

In the method of the present invention that the water treatment system operates in two states, deionization state and reverse polarization state.

In the method of the present invention that the FL bypasses the electrochemical cell and it is preferred that the FL is operably functional through a valve FLV so that the line is operational only when it is in reverse polarization/regeneration state.

In the method of the present invention that when the electrochemical cell is in deionization state, the water enters the inlet into line L₀, subsequently entering the prefilter, and entering lines L₁ and L₂ at point M. Water in line L₁ preferably passes through open valve V1A and enters into the electrochemical cell finally exits the electrochemical cell to enter line L₁ and then merges with line L₂ into line L₀ at point N. It is preferred that the water from point M which enters into the reverse osmosis unit is treated at the unit and the reject water is discarded through the RO reject outlet, preferably through the valve WLV2. The treated RO permeate water then merges with line L₁ at point N. Subsequently, the water downstream of point N in line L₀ is filtered through the carbon filtration unit and collected through the treated water outlet.

It is preferred that in the method of the present invention that during the deionization stage, the lines FL and WL1 are closed and through operably functional valves FLV and WLV1 respectively.

In the method of the present invention that when the electrochemical cell is in reverse polarization/regeneration state, the line L₀ is open and the water is allowed to enter lines L₁ and L₂ through point M, the reject water line WL2 of RO unit is closed and the output water line is closed through operably functional valve V2, preferably line L₁ beyond point O is closed to restrict the entry of water into electrochemical cell from line L₁. Instead, the reject water from RO flows back into the RO unit and into L₂ into line L₁ and subsequently into line FL preferably through operably functional valve FLV, through point P into the electrochemical cell in a direction opposite to the flow of water during deionization state. The water passing through the electrochemical cell from point P subsequently passes through the cell and the waste water enters into line WL1 and discarded into waste water outlet preferably through operably functional valve WLV1.

It is preferred that the trigger to enter the state of deionization is programed based on a predetermined volume of water which is treated by the device. It is preferred that a flow sensor is positioned before the valve V2 which senses the volume of water treated by the device. It is further preferred that the Electrochemical cell assembly remains in the state of regeneration for a predetermined period of time before it again transitions back to the state of deionization by reversing of polarity.

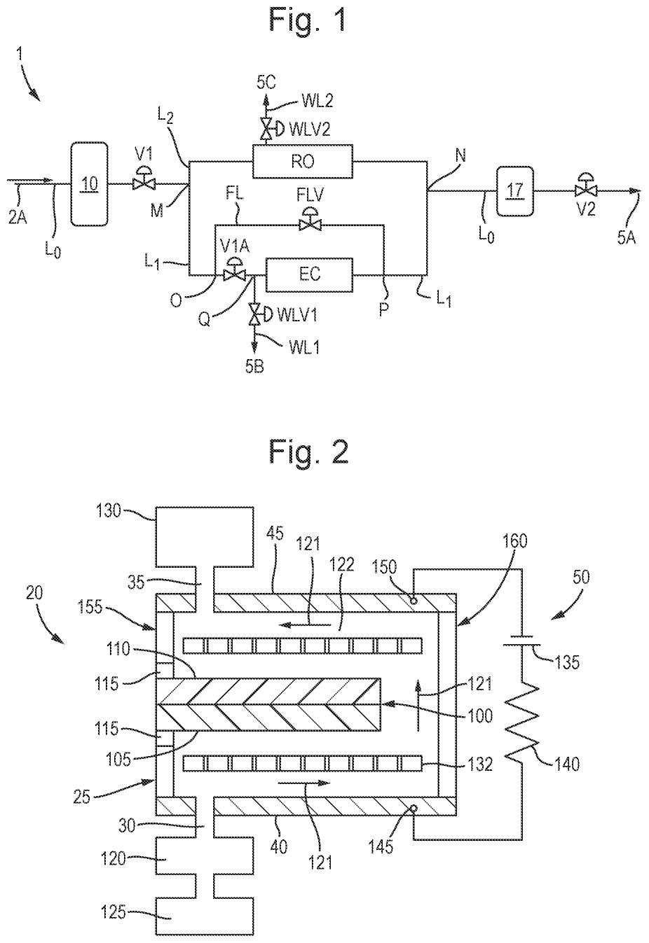

FIG. 1 presents the flow diagram of water treatment device 1 of the present invention comprising a first inlet (2A) feeding water into line L₀; a prefiltration unit (10); a water treatment unit comprising an electrochemical cell assembly (20) comprising of at least one electrochemical cell; and a reverse osmosis unit (RO), wherein the electrochemical cell assembly (20) and the reverse osmosis unit (RO) are connected in parallel; and wherein the electrochemical cell (EC) comprises: a housing (25) having first (40) and second (45) electrodes; at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution; wherein the line L₀ branches into lines L₁ and L₂ at point M, line L₁ leading to the electrochemical cell (EC) and L₂ leading to the reverse osmosis unit (RO); wherein L₁ further branches into line FL at point O, upstream of the electrochemical cell (EC), to form a bypass loop to the electrochemical cell (EC) and merges back into the line L₁ at point P, downstream of the electrochemical cell (EC); and wherein lines L₁ and L₂ merge back into line L₀ at point N downstream of the electrochemical cell (EC) and the reverse osmosis unit (RO); a wastewater line (WL1) for discarding wastewater from the electrochemical cell (EC), through the waste water outlet (5B); a wastewater line (WL2) for discarding reject water from the reverse osmosis unit (RO), through the reject water outlet (5C); a carbon filtration unit (17) positioned on line L₀ downstream of the point N; an outlet (5A) for dispensing treated water.

The Figure shows a water treatment device (1) having a first inlet (2A) leading to a first feeding line L₀ which is in fluid communication with a prefilter (10) which allows the raw or unfiltered water to filter through a prefiltration unit (10) which functions to remove suspended solids, for example particles, rust, colloid and etc. the water line exiting from the prefiltration unit L₀ is preferably divided into lines L₁ and L₂ at point M, preferably a valve V1 is positioned downstream of the prefiltration unit (10) and upstream of point M; L₂ is preferably the route to the reverse osmosis unit (RO); L₁ is the line leading to electrochemical cell (EC) via valve V1A and preferably branches into file FL at point O, it is preferred that valve V1A is downstream of point O and more preferable that the point O and valve V1A are positioned upstream of the electrochemical cell (EC).

It is shown that the line L₁ further branches out at point Q to waste water line WL1, and that the point Q is positioned between valve V1A and electrochemical cell (EC), and downstream of valve V1A and upstream of the electrochemical cell. A valve WLV1 is positioned on the waste water line WL1. Waste water from the electrochemical cell (EC) flows out through the waste water outlet (5B) via waste water line WL1.

It is shown that the line FL has a valve FLV positioned on it and that the line FL bypasses the electrochemical cell (EC) and merges into line L₁ downstream of the electrochemical cell (EC) at point P.

It is shown that that the line L₁ and line L₂ merge back into line L₀ downstream of the reverse osmosis unit (RO) and the electrochemical cell at point N and a valve V2 is positioned on line L₀ and valve V2 is positioned downstream of the carbon filtration unit (17) on Line L₀ and further preferably the treated water is collected from treated water outlet (5A) positioned downstream of the valve V2.

It is shown that the line L₂ leads to the reverse osmosis unit (RO) and that the reject water of the reverse osmosis unit (RO) flows into waste water line WL2 and a valve WLV2 is positioned on the line WL2. It is shown that the reject of reverse osmosis unit (RO) flows out through RO reject outlet (5C).

FIG. 2 presents one embodiment of an electrochemical cell assembly 20 of the present invention comprising a housing 25 having at least one inlet 30 for introducing an influent solution stream into the cell, and one outlet 35 that provides a single effluent solution. Opposing first and second electrodes 40, 45 in the cell are powered by electrode voltage supply 50 that supplies a voltage across the electrodes. At least one water-splitting membrane 100 is positioned between the electrodes 40, 45 in the housing 25. Each water-splitting membrane 100 comprises at least one combination of adjacent and abutting cation exchange surface 105 (typically a cation exchange layer having cationic exchange groups) and an anion exchange surface 110 (typically comprising an anion exchange layer having anionic exchange groups). The water-splitting membranes 100 are arranged in the housing 25 so that the cation exchange surfaces of the membranes face the first electrode 40, and the anion exchange surfaces of the membranes face the second electrode 45.

A solution stream pathway (as represented by the arrows 121) is defined by the surfaces of the water-splitting membranes 100, the electrodes 40, 45, and the sidewalls of the cell. The solution stream pathway 121 (i) extends from the inlet 30 (which is used for introducing an influent solution stream into the solution stream pathway), (ii) includes at least one channel that allows the influent solution stream to flow past at least one surface of the water-splitting membrane to form one or more treated solution streams, and (iii) terminates at a single outlet 35 that combines the treated solution streams to form a single effluent solution. The solution stream pathway 121 can comprise a single serial flow channel extending continuously through the cell, or can comprise a plurality of parallel flow channels that are connected and terminate at a single outlet 35. In the embodiment in FIG. 2, the water-splitting membranes 100 are arranged to provide a solution stream pathway 121 having an unitary and contiguous solution channel 122 that flows past both the cation and anion exchange surfaces of the water-splitting membrane.

Preferably, the channel 122 is connected throughout in an unbroken sequence extending continuously from the inlet to the outlet, and flowing past the anion and cation exchange surfaces of the water-splitting membranes. Thus, the unitary and contiguous channel's perimeter comprises at least a portion of all the cation and anion exchange layer surfaces of the water-splitting membranes in the cell.

The housing 25 typically comprises a plate and frame construction fabricated from metal or plastic and comprises one or more inlet holes 30 to introduce solution into the cell and one or more outlet holes 35 to remove effluent solution from the cell. While one or more outlet holes can be provided, the effluent solution from the cell preferably comprises a single effluent solution stream that is formed before or after the outlet holes (for example in an exhaust manifold that combines the different solution streams). The water-splitting membranes 100 are held in the housing 25 using gaskets 115 positioned on either side of the water-splitting membrane. A pump 120, such as for example, a peristaltic pump or water pressure in combination with a flow control device, is used to flow solution from a solution source 125 through the channel 122 and into a treated solution tank 130. In this embodiment, the pump 120 serves as means to flow a single solution stream through the cell. An electrode voltage supply 50, typically external to the electrochemical cell 20, comprises a direct current voltage source 135 in series with a resistor 140. The electrical contacts 145, 150 are used to electrically connect the voltage supply 50 to the first and second electrodes 40, 45. Instead of a DC current source, the voltage source can also be a rectified alternating current source, for example, a half-wave or full-wave rectified alternating current source.

The anode and cathode electrodes 40, 45 are fabricated from an electrically conductive material, such as a metal which is preferably resistant to corrosion in the low or high pH chemical environments created during positive and negative polarization of the electrodes during operation of the cell 20. Suitable electrodes can be fabricated from copper, aluminum, or steel cores which are coated with a corrosion-resistant material such as platinum, titanium, or niobium. The shape of the electrodes 40, 45 depends upon the design of the electrochemical cell 20 and the conductivity of the solutions flowing through the cell. The electrodes 40, 45 should provide a uniform voltage across the surfaces of the water-splitting membranes 100, a suitable electrode shape for cell 20 being a flat plate dimensioned approximately as large as the area of the water-splitting membrane, positioned at the top and the bottom of the cell 20, and having an electrode surface interior to the housing. Preferably, the first and second electrodes 40, 45 comprise planar structures on either side of planar water-splitting membranes 100 positioned adjacent to one another. Alternative electrode shapes include distributed designs such as woven screens, expanded meshes, or wire shaped in a particular configuration, for example, a serpentine shape. For source solution to enter and exit cell 20, as for example in the embodiment in FIG. 2, it may be necessary to cut openings in the two electrodes 40 and 45 to allow solution to pass into and out of channel 122.

Preferably, the electrodes 40, 45 are constructed of two or more layers that provide the desired combination of electrical conductivity and corrosion resistance. A suitable configuration comprises an inner electrically conductive layer which has a sufficiently low electrical resistance to provide substantially uniform voltage across water-splitting membranes 100; a corrosion resistant layer to prevent corrosion of the electrically conductive layer; and a catalytic coating on the surface of the electrode to reduce operating voltages, extend electrode life, and minimize power requirements. A preferred electrode structure comprises a copper conductor covered by corrosion-resistant material such a titanium or niobium, and thereafter coated with a noble metal catalyst layer such as platinum.

The gaskets 115 separating the water-splitting membranes 100 in cell 20 and forming its sidewalls 155, 160 have multiple functions. In the first function, the gaskets 115 prevent leakage of the solution through the sidewalls 155, 160 of the cell 20. In another function, the gaskets 115 are made of an electrically insulating material to prevent shorting or divergence of the electrical current channel through the sidewalls 155, 160 of the cell 20. This forces the electrical current channel, or the electrical field between the electrodes 40, 45, to be directed substantially perpendicularly through the plane of the water-splitting membranes 100 to provide more efficient ion removal or replacement. Within solution channel 122 are preferably positioned spacers 132, for example, layers of plastic netting material suspended form the sidewalls of the cell. Spacers 132 serve several functions: they separate water-splitting membranes 100, provide more uniform flow, and create turbulence in the solution stream pathway to provide higher ion transport rates. If two or more water-splitting membranes are in direct contact, excess current may flow through this low resistance path, overheating the membranes and bypassing the solution (thereby reducing cell performance). This spacer may be of any construction having an average pore size or opening greater than 10 μm in diameter. Solution channel 122 in the cell may also comprise ion exchange material particles or filaments, for example beads, granules, fibers, loosely woven structures, or any other structure which allows the solution in the channel 122 to contact both the cation and anion exchange layer surfaces of the water-splitting membranes that form a portion of the periphery of the channel. Any ion exchange material located in channel 122 still provides a single, contiguous solution stream in cell 20. The ion exchange material in channel 122 may comprise cation exchange material, anion exchange material, or a mixture of the two. However, the ion exchange material located in channel 122 should not be in the form of a monopolar ion exchange membrane that separates two or more solution streams in the cell. Thus, the cell preferably comprises substantially no monopolar ion exchange membranes between adjacent water-splitting membranes.

The water-splitting membrane 100 is any structure comprising a cation exchange surface 105 and an anion exchange surface 110 in combination such that under a sufficiently high electric field, produced by application of voltage to electrodes 40 and 45, water is dissociated into its component ions H⁺ and OH⁻ in the membrane. This dissociation occurs most efficiently at the boundary between the cation and anion exchange surfaces or layers in the membrane, or in the volume between them, and the resultant H⁺ and OH⁻ ions migrate through an ion exchange layer in the direction of the electrode having an opposite polarity. For example, H⁺ will migrate toward the negative electrode (cathode), and OH will migrate toward the positive electrode (anode). Preferably, the water-splitting membrane comprises abutting cation and anion exchange layers 105, 110 that are secured or bonded to each other to provide a water-splitting membrane 100 having a unitary laminate structure. The cation and anion exchange layers 105, 110 can be in physical contact without a bond securing them together, or the water-splitting membrane 100 can include a non-ionic middle layer, for example a water-swollen polymer layer, a porous layer, or a solution-containing layer.

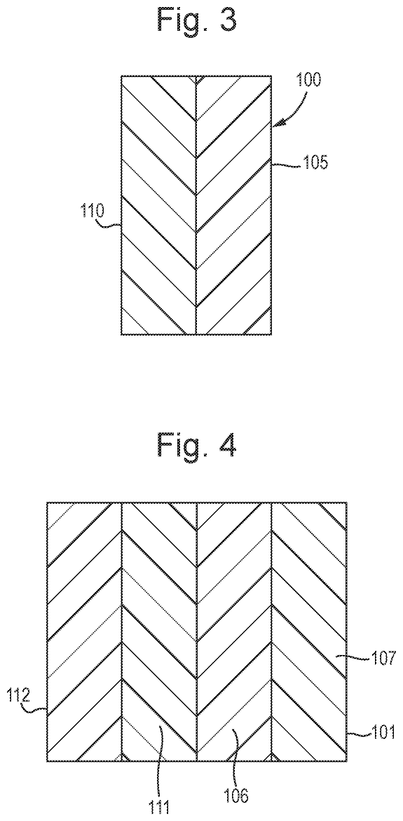

An expanded sectional diagram of an embodiment of a water-splitting membrane 100 comprising abutting cation and anion exchange surfaces or layers is shown in FIG. 3. Suitable cation exchange layers 105 can comprise one or more acidic functional groups capable of exchanging cations such as —SO₃M, —COOM, —PO₃M₂, —C₆H₄OM, where M is a cation (e.g., hydrogen, sodium, calcium, or copper ion). Cation exchange materials also include those comprising neutral groups or ligands that bind cations through coordinate rather than electrostatic or ionic bonds (for example pyridine, phosphine and sulfide groups), and groups comprising complexing or chelating groups (e.g., those derived from aminophosphoric acid, aminocarboxylic acid, and hydroxamic acid). The choice of cation exchange functional group depends upon the application of the cell 20. In water deionization for which the non-selective removal of ions is required, —SO₃M groups are preferred for their ability to impart good membrane swelling, high mass transport rates, and low electrical resistances over a wide range of pH. For the selective removal of copper ion from a liquid containing other ions, for example sodium ion, ion exchange groups such as —COOM or a chelating group such as aminocarboxylic acid are preferred. These weak acid groups offer the additional benefit of particularly efficient regeneration due to the strongly favorable reaction of —(COO)nM with H⁺ to form —COOH and expel M⁺ⁿ, where M is a metal ion.

Suitable anion exchange layers 110 of water-splitting membrane 100 comprise one or more basic functional groups capable of exchanging anions such as —NR₃A, —NR₂HA, —PR₃A, —SR₂A, or C₅H₅NHA (pyridine), where R is an alkyl, aryl, or other organic group and A is an anion (e.g., hydroxide, bicarbonate, chloride, or sulfate ion). The choice of anion exchange functional group also depends on the application. In water deionization, —NR₃A is preferred for its ability to impart good membrane swelling, and thus provide low electrical resistances and high mass transport rates, over a wide range of pH. Weak base groups are preferred when particularly efficient regeneration is required. For example, —NR₂HA will react with OH⁻ in a very favorable reaction to form —NR₂, H₂O, and expel A⁻.

The water-splitting ion exchange membranes can also comprise more than two anion and cation exchange layers. Water-splitting membrane 101 in FIG. 4 is an embodiment comprising four ion exchange layers: two cation exchange layers 106 and 107 and two anion exchange layers 111 and 112. The two cation or two anion exchange layers may differ in ion exchange capacities or ion exchange functional groups. For example, the inner cation exchange layer 106 of water-splitting membrane 101 may comprise substantially —SO₃ groups and the outer layer 107 comprise —COOH groups; while the inner anion exchange layer 111 may comprise —NR₃ groups and the outer layer 112 comprise —NR₂H groups. Alternatively, cation exchange layers 106 or 107 or anion exchange layers 111 or 112 can be porous to hold solution. The porous layers may be open cell foams, for example prepared using foaming agents or leaching techniques, woven and non-woven fiber composites comprising ion exchange granules, or any other structure which provides fast solution transport through at least a portion of the water-splitting ion exchange membrane thickness, thereby increasing the rate of solution contact with ion exchange material contained within the porous layer and increasing the rate of solution flow through the cell. Preferably, the porous layers have an average pore diameter of at least 1 μm, more preferably greater than 10 μm; and pore volumes of at least 10% of the porous layer volume, and more preferably at least 20%.

The water-splitting ion exchange membranes may be prepared by any method, for example those which provide homogeneous or heterogeneous ion exchange membranes. Homogeneous membranes are formed by polymerizing appropriate monomers followed by one or more chemical steps to introduce the ion exchange groups. Typically, a monomer which cross-links the resultant polymer is included to provide an insoluble ion exchange material. Polymerization may take place in the presence or absence of a solvent, and depending on the choice of solvent, one obtains ion exchange materials which can be further characterized as gel (prepared without solvent), isoporous (good monomer and polymer solvent), or macroporous (good monomer but poor polymer solvent). A typical method for preparing homogeneous membranes is to cast monomer mixtures between glass sheets, taking care to prevent monomer or solvent evaporation, and heating to cure. Subsequent chemical functionalization is as for other ion exchange materials (e.g., beads). Water-splitting membranes may be prepared by several related methods including casting a second monomer mixture on a cured layer followed by stepwise chemical functionalization of the two layers, or by the chemical functionalization of a single cast layer from the two sides using different functionalization chemistry.

Heterogeneous water-splitting ion exchange membranes comprise a host polymer intimately mixed with particles of homogeneous ion exchange material. The ion exchange particles absorb substantially more water than the host polymer, with the latter providing the membrane with structural integrity. Since the ion exchange particles are typically larger than one micron in cross-section, these water-splitting membranes have a heterogeneous structure on the micron scale. A preferred method of preparing heterogeneous membranes is by melt blending ion exchange material, for example in a granulated form, and thermoplastic polymers, for example polyethylene, polyethylene copolymers, or polyvinylidene fluoride. Any process suitable for melt blending the host polymer may be employed, for example using a roll mill or mixing extruder. Individual, thin sheets of ion exchange material may be formed by, for example, compression molding or extrusion, and water-splitting membranes may be formed from two or more layers by the same methods.

The ion exchange material for use in heterogeneous water-splitting membranes is preferred to have an average particle size less than 200 microns, more preferably, less than 100 microns. Small particles may be obtained by direct synthesis of small beads, for example in emulsion polymerization, or by granulating larger ion exchange beads having the desired chemical and physical properties. For the preparation of the heterogeneous membranes used for the examples described herein, granulated ion exchange resins were obtained from Graver Chemical Company: PCH strong acid cation exchange resin (H⁺ form) and PAO strong base anion exchange resin (OH⁻ form). The volume fraction of ion exchange material in the cation and anion exchange layers of heterogeneous water-splitting membranes is preferred to be at least 30%, more preferably at least 35%, most preferably at least 40%.

The choice of host polymer for use in heterogeneous membranes depends upon the requirements for the resultant water-splitting membranes and the maximum processing temperatures allowable for the ion exchange material. For example if stiff, incompressible membranes are required for a plate and frame construction cell, as shown in FIG. 2, one may select a host polymer such as high density polyethylene (HDPE). In contrast, a spiral construction cell may require flexible water-splitting membranes, and an elastomer such as ethylene-propylene thermoplastic may be preferred. Alternatively, the host polymer may be a water-swellable material, for example poly(ethylene oxide) or polyvinylalcohol. This may provide faster ion transport through the ion exchange layers of the water-splitting membranes. To avoid dissolution of water swellable polymer, it may be advantageous to cross-link the host polymer/ion exchange material composite to provide an insoluble, cross-linked structure. Cross-linking may be accomplished after forming the composite into the final shape (e.g., sheets) either using chemical agents or radiation (for example UV, electron or gamma radiation). Cross-linking may also provide mechanical benefits to non-water swellable host polymer composites, for example improved tear resistance.

The cation and anion exchange layers of the water-splitting membranes preferably comprise ion exchange capacities of at least about 0.1 meq/cc, more preferably at least 0.2 meq/cc, and most preferably at least 0.5 meq/cc. Higher ion exchange capacities result in increased membrane swelling in solution and lower electrical resistance. Higher ion exchange capacity also provides an apparatus which requires less frequent regeneration for a given volume of water-splitting membrane material. Another approach to reducing the frequency of the regeneration step is to use water-splitting membranes having greater thickness to increase ion exchange capacity. Preferably, the water-splitting membranes have a solution saturated thickness of at least about 200 microns (μm), more preferably at least 400 μm, most preferably at least 600 μm.

### Example 1

The water treatment device is assembled according to the first aspect of the present invention. A water treatment process was constructed according to the first aspect of the present invention for this example. A water treatment process was constructed as described below. An ultrafiltration (from Truliva) was used as the pre-filter. 2 filter (400G RO filter or 400G electrochemical cell cartridge) were used as the main salt removal unit. 400G electrochemical cell cartridge is composed of 25 layers 15.6 cm×40 cm electronically regenerated ion exchange membrane and could treat 6 L water (<400 ppm after regeneration). An active carbon filter (From Kortech) was used as the postfilter. Totally, 2 pieces Ti electrodes were used for the electrochemical cell cartridge. A central rising tube was in the electrochemical cell cartridge housing to hold the inner electrode. The other piece was fixed on the inner side of the cartridge housing. A 300V power supply was attached to the 2 pieces of electrode providing an electric field.

100 ppm NaCl aqueous solution was used as the feed water. The feed water was introduced to the system at the flow rate of 2 L/min. After treated by UF, salt was removed by filter 1 and filter 2 and finally collect after treated by activated carbon.

The reaction was firstly performed using two 400G 75% water recovery RO filter and then replaced the one of the RO filter by a 400G electrochemical cell cartridge.

TABLE 1

| | Performance | | | |
|---|---|---|---|---|
| | Output | | Water | Water |
| | Flow | | recovery during | recovery of |
| System | rate | | deionization | whole system |
| 2 RO units connected | 1.5 | L/min | 75% | 75% |
| in parallel | | | | |
| RO + electrochemical | 1.75 | L/min | 88% | 84% |
| cell cartridge | | | | |
| (in parallel) | | | | |

For the system using two 400G RO filters, the water recovery of the 400 RO was 75% resulting to 0.75 L/min product water of each RO unit. Therefore, the product water flow rate of the whole system was 1.5 L/min, that's 75% water recovery of the system.

During the deionization stage of electrochemical cell cartridge, no waste water was generated. So, the product water flow rate of electrochemical cartridge was 1 L/min, product water of RO filter was 0.75 L/min, resulting to 1.75 L/min product water of the whole system. So the water recovery of the system during deionization stage was 88%.

When the feed water TDS was 100 ppm, after treating 24 L water regeneration was necessary. When electrochemical cell cartridge produced 24 L water, RO produced 18 L product water and 6 L wastewater. During the regeneration stage, the waste water used was about 2 L. The water recovery of the whole system was (24+18)/(24+24+2)=84%.

Compared with using two 400G RO in parallel, using one electrochemical cell cartridge to replace one of the RO filter can increase the system water recovery rate. At the same time, the system could work continuously compared with system using only Electrochemical cartridges.

1. A water treatment device (1) comprising:
a) a first inlet (2A) feeding water into line L₀;
b) a prefiltration unit (10);
c) a water treatment unit comprising an electrochemical cell assembly (20) comprising of at least one electrochemical cell; and a reverse osmosis unit (RO), wherein the electrochemical cell assembly (20) and the reverse osmosis unit (RO) are connected in parallel; and wherein the electrochemical cell (EC) comprises:
(i) a housing (25) having first (40) and second (45) electrodes;
(ii) at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and
(iii) a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution;
wherein the line L₀ branches into lines L₁ and L₂ at point M, line L₁ leading to the electrochemical cell (EC) and L₂ leading to the reverse osmosis unit (RO);
wherein L₁ further branches into line FL at point O, upstream of the electrochemical cell (EC), to form a bypass loop to the electrochemical cell (EC) and merges back into the line L₁ at point P, downstream of the electrochemical cell (EC); and
wherein lines L₁ and L₂ merge back into line L₀ at point N downstream of the electrochemical cell (EC) and the reverse osmosis unit (RO);
d) a wastewater line WL1 for discarding wastewater from the electrochemical cell (EC), through the waste water outlet (5B);
e) a wastewater line WL2 for discarding reject water from the reverse osmosis unit (RO), through the reject water outlet (5C);
f) a carbon filtration unit (17) positioned on line L₀ downstream of the point N; and
g) an outlet (5A) for dispensing treated water
wherein:
a valve V1 is positioned on the line L₀ downstream of prefiltration unit (10) and upstream of point M;
a valve V2 is positioned downstream of carbon filtration unit (17) on line L₀;
a valve V1A is positioned on line L₁, downstream of point O and upstream of the electrochemical cell (EC);
a valve FLV is positioned on the line FL
a valve WLV1 is positioned on the wastewater line WL1; and
a valve WLV2 is positioned on the wastewater line WL2.

2. The device (1) according to claim 1, wherein the solution stream pathway (121) comprises a unitary and contiguous solution channel that flows past both the cation and anion exchange surfaces (105, 110) of the water-splitting membrane (100).

3. The device (1) according to claim 1, wherein the cell (20) comprises a plurality of water-splitting membranes (100), and wherein the solution stream pathway (121) comprises a unitary and contiguous solution channel (122) that flows past (i) the electrodes (40,45), and (ii) both the cation and anion exchange surfaces (105, 110) of each water-splitting membrane (100).

4. The device (1) according to claim 1, the cell (20) comprising a plurality of interdigited water-splitting membranes (100) having alternating ends attached to the housing (25).

5. The device (1) according to claim 1, wherein (i) the water-splitting membranes (100) are rolled in a spiral arrangement to form a cylindrical shape, and (ii) the first or second electrode (40,45) comprises a cylinder enclosing the spiral arrangement of water-splitting membranes (100).

6. The device (1) according to claim 5, wherein the solution stream pathway (121) allows the influent solution stream to flow past both the cation and anion exchange layer surfaces (105,110) of the water-splitting membranes (100) in the direction of the spiral.

7. The device (1) according to claim 1, wherein the water-splitting membrane (100) comprises at least one of the following characteristics:
a) a cation exchange surface (105) comprising a chemical group selected from the group consisting of —SO₃M, —COOM, —PO₃M₂, —C₆H₄OM, aliphatic amines, aromatic amines, aliphatic phosphines, aromatic phosphines, aliphatic sulfides, aromatic sulfides, aminophosphoric acid, aminocarboxylic acid, hydroxamic acid, and mixtures thereof, where M is a cation;
b) an anion exchange surface (110) comprising a chemical group selected from the group consisting of aliphatic amines, aromatic amines, aliphatic phosphines, aromatic phosphines, aliphatic sulfides, aromatic sulfides, and mixtures thereof; or
c) the membranes are heterogeneous and comprise cross-linked water-swellable polymeric host material.

8. The device (1) according to claim 1, wherein the cation exchange surfaces (105) of the water-splitting membranes (100) comprise at least two cation exchange layers each comprising different cationic chemical groups.

9. The device (1) according to claim 9, wherein an inner cation exchange layer comprises SO₃⁻ chemical groups, and an outer cation exchange layer comprises an ion exchange chemical group other than SO₃⁻.

10. The device (1) according to claim 1, wherein the anion exchange surfaces (110) of the water-splitting membranes (100) comprise at least two anion exchange layers each comprising different cationic chemical groups.

11. The device (1) according to claim 11, wherein an inner anion exchange layer comprises NR₃⁺ groups, and an outer anion exchange layer comprises ion exchange groups other than NR₃⁺, where R is selected from the group consisting of aliphatic hydrocarbons, aliphatic alcohols, and aromatic hydrocarbons.

12. A method of treating water according to the device of claim 1, the method comprising steps of:
(i) allowing the water to filter through the prefiltration unit (10)
(ii) treating water in the water treatment unit comprising an electrochemical cell assembly (20) comprising of at least one electrochemical cell (EC); and a reverse osmosis unit (RO), wherein the electrochemical cell assembly (20) and the reverse osmosis unit (RO) are connected in parallel, each cell (20) comprising:
a) first and second electrodes (40, 45);
b) at least one water-splitting membrane between the electrodes, each at least one water-splitting membrane (100) between the electrodes (40, 45), each water-splitting membrane (100) comprising ion exchange layers A and B, one a cation exchange layer facing the first electrode (40) and the other an anion exchange layer facing the second electrode (45), which layers contain ions I_{1A} and I_{1B} respectively;
wherein a unitary and contiguous solution channel is defined by the cation and anion exchange layer surfaces (105, 110) of the membranes, the solution channel (122) abutting both electrodes (40, 45) and extending continuously from the inlet (30) to the outlet (35) of the housing (25);
c) an ion-containing solution electrically connecting the electrodes (40, 45) and the water-splitting membranes (100);
in which cell ions I_{1A} and I_{1B} are replaced by ions I_{2A} and I_{2B}, respectively;
wherein the water-splitting membranes (100) are arranged to provide a continuous channel (122) that allows a stream of solution to flow past both the cation and anion exchange layer surfaces (105, 110) of the water-splitting membranes (100);
wherein the solution in at least one channel (122) of the cell (20) is simultaneously exposed to a cation and an anion exchange layer surface (105, 110) of water-splitting membranes (100); and
(iii) allowing the water from the electrochemical cell assembly (20) to be filtered by the carbon filtration unit (17);
wherein at a given point in time the device operates in anyone of the two stages, deionization state and regeneration stage and the water obtained by the method steps (i) to (iii) are during the deionization stage,
wherein when the device is in regeneration stage, the electrochemical cell (EC) allows water to flow from L₁ through point O into the feed water line FL into the into the electrochemical cell (EC) though point P in opposite direction with respect to flow of water during the deionization stage; and water exiting from the electrochemical cell (EC) which is in the stage of regeneration is discarded through waste water line WL1
wherein during the regeneration stage valves V1, FLV and WLV1 are open and valves and V2, V1A, and a valve WLV2 positioned on the line WL2 are closed and during the deionization stage, valves FLV and WLV1 are closed and valves V1, V1A, WLV2 and V2 are open.
